(19) United States
(12) Patent Application Publication
(10) Pub. No.: US 2012/0202081 A1
(43) Pub. Date: Aug. 9, 2012

(54) LIGHT-BLOCKING MEMBER FOR OPTICAL INSTRUMENT

(76) Inventors: Junko Takahashi, Tokyo (JP); Masahiro Harada, Tokyo (JP)

(21) Appl. No.: 13/502,461

(22) PCT Filed: Sep. 15, 2010
(86) PCT No.: PCT/JP2010/065979

§ 371 Date: Apr. 17, 2012

(30) Foreign Application Priority Data
Oct. 29, 2009 (JP) 2009-248922
Dec. 10, 2009 (JP) 2009-280363

(51) Int. Cl. B32B 27/06; F21V 9/00

(52) U.S. Cl. 428/473.5; 252/582

(57) ABSTRACT

A light-blocking member for optical instruments having improved abrasion resistance and adhesiveness while having high sliding properties and maintaining physical properties of a light-shielding layer, such as light-shielding properties and delustering properties, is provided. A light-blocking member for optical instruments can include a film substrate 2 and a light-shielding layer formed on at least one surface of the substrate. The light-shielding layer can include a binder resin, carbon black, a particulate lubricant and fine particles. Contents of the binder resin and particulate lubricant are 65 wt % or higher and 5 to 15 wt %, respectively. As the particulate lubricant, those having a higher density than that of the fine particles can be used.

This application is a U.S. national phase filing under 35 U.S.C. §371 of PCT Application No. PCT/JP2010/065979, filed Sep. 15, 2010, and claims priority under 35 U.S.C. §119 to Japanese patent applications no. 2009-248922, filed Oct. 29, 2009, and 2009-280363, filed Dec. 10, 2009, the entireties of all of which are incorporated by reference herein.

### TECHNICAL FIELD

The present invention relates to a light-blocking member (=light-shielding member. The following is the same.) for optical instruments and is usable for shutter and diaphragm members of various optical instruments.

### BACKGROUND ART

In recent years, due to demands for reduction in size and weight of various optical instruments, such as high-end single-lens reflex cameras, compact cameras and video cameras, members of a shutter and diaphragm of optical instruments, which have been made of metal materials, have shifted to plastic materials. As a diaphragm made of plastic materials as such, there has been known a light-shielding film wherein a light-shielding layer containing carbon black, a lubricant, fine particles and a binder resin is formed on a film substrate (patent documents 1 and 2).

### RELATED ART DOCUMENT

### Patent Document

Patent Document 1: Japanese Patent Unexamined Publication (Kokai) No. H09-274218
Patent Document 2: PCT Patent Publication No. WO2006/016555

### SUMMARY

The light-shielding film made by the conventional method as above had to contain a large amount of lubricant in the light-shielding layer to enhance the sliding properties. As a result, first, the large amount of lubricant was liable to deteriorate abrasion resistance of the light-shielding layer. Second, a content of fine particles in the light-shielding layer had to be lowered, therefore, although it may provide good light-shielding properties, delustering properties could not be developed sufficiently.

In recent years, when mounting a lens on a camera of a cellular phone, attaching by using reflow soldering has drawn attentions when mounting the lens on a substrate. Reflow soldering is an attachment method by applying creamy soldering on a substrate, then, feeding the same to a reflow furnace and melting the soldering for adhering. According to the method of attaching a lens with reflow soldering, productivity of camera-equipped cellular phones can be dramatically improved comparing with the case of the conventional attachment methods.

When mounting a light-shielding film on a cellular phone camera, the light-shielding film is required to have high heat-resistance at a level of enduring the condition of attaching a lens by reflow soldering explained above. However, as explained above, since light-shielding films by the conventional method had to contain a large amount of lubricant in the light-shielding layer, a content of a binder resin in the light-shielding layer became low and adhesiveness between the light-shielding layer and the film substrate was not enough.

An aspect of the present invention is to provide a light-blocking member for optical instruments with improved abrasion resistance and adhesiveness while having high sliding properties and maintaining physical properties of the light-shielding layer, such as light-shielding properties and delustering properties. Another aspect of the present invention is to provide a light-blocking member for optical instruments with improved heat resistance and adhesiveness while having high sliding properties and maintaining physical properties of the light-shielding layer, such as light-shielding properties and delustering properties.

The present inventors have focused on densities of fine particles and particulate lubricant and found that it became possible to reduce an amount of the lubricant on the light-shielding layer surface by using a lubricant having a higher density (specific lubricant) than that of fine particles and, consequently, abrasion resistance of the light-shielding layer was improved. Also, they found that it became possible to develop high sliding properties with a small blending amount when using a specific lubricant. When using the specific lubricant found by the inventors, high sliding properties can be obtained with a small blending amount, so that the blending amount of a lubricant in the light-shielding layer can be reduced. As a relative effect thereof, a binder resin amount in the light-shielding layer can be increased, as well. Consequently, improvement of adhesiveness of the light-shielding layer to the film substrate can be expected.

Namely, according to a first aspect of the present invention, there is provided a light-blocking member (1) for optical instruments, comprising a film substrate (2) and a light-shielding layer (3) formed on at least one surface of the substrate, wherein the light-shielding layer (3) comprises a binder resin, carbon black (31), a particulate lubricant (32) and fine particles (33). In this case, contents of the binder resin and the lubricant are 65 wt % or higher and 5 to 15 wt %, respectively. As the particulate lubricant (32), those having a higher density than that of the fine particles (33) are used.

On the other hand, the present inventors found that, by using a specific particulate lubricant, it became possible to develop high sliding properties even with a small blending amount. The reason is not clear but they found that when choosing fluorine resin particles from a number of particulate lubricants to use, high sliding properties could be obtained with a small blending amount, consequently, contents of carbon black and fine particles could be increased and it was possible to maintain the physical properties of the light-shielding layer, such as light-shielding properties and delustering properties. Also, they successfully increased an amount of a binder resin in the light-shielding layer as a relative effect of decreasing a blending amount of the lubricant to small. As a result, they found that improvements of heat resistance and adhesiveness of the light-shielding layer can be expected and it is possible to contribute to an improvement of abrasion resistance of the light-shielding layer.

Namely, according to a second aspect of the present invention, there is provided a light-blocking member (1) for optical instruments, comprising a film substrate (2) and a light-shielding layer (3) formed on at least one surface of the substrate, wherein the light-shielding layer (3) comprises a binder resin, carbon black (31), fluorine resin particles (32) and fine particles (33). In this case, contents of the binder resin and the fluorine resin particles (32) are 65 wt % or higher and 5 to 15 wt %, respectively. A weight ratio of the fluorine resin particles (32) and the fine particles (33) is 5 or lower in fluorine resin particles (32)/fine particles (33).

In the invention according to the first aspect, a content of the lubricant (32) in the light-shielding layer (3) may be 10 wt % or lower. Also, a density of the lubricant may be 2.0 (g/cm³) or higher. Also, as the lubricant (32), those having an average particle size of 5 to 10 μm may be used. Also, fluorine resin particles may be used as the lubricant.

In the invention according to the second aspect, a content of the fluorine resin particles (32) in the light-shielding layer (3) may be 10 wt % or lower. Also, a weight ratio of the fluorine resin particles (32) and the fine particles (33) may be 3 or lower in fluorine resin particles (32)/fine particles (33). Also, as fluorine resin particles (32), those having an average particle size of 5 to 10 μm may be used.

In the invention of the both aspects, contents of the carbon black and fine particles (33) may be 5 to 20 wt % and 1 to 10 wt %, respectively. Also, the binder resin may be composed of a thermosetting resin. Also, the film substrate (2) may be composed of a polyimide film. Also, as the fine particles (33), those having oil absorption of 250 (g/100 g) or more may be used.

Note that in the means above, explanations were made with reference numbers corresponding to the drawings showing the embodiment of the invention, but the reference numbers are to facilitate understandings of the invention and not to limit the invention.

According to the invention of the first aspect, by using a specific particulate lubricant, that is, a particulate lubricant having a higher density than that of fine particles as the lubricant to be contained in the light-shielding layer, an amount of lubricant residing on the light-shielding layer surface can be reduced, consequently, it is possible to obtain a light-blocking member for optical instruments wherein abrasion resistance of the light-shielding layer is improved. By using a specific lubricant as such, the light-shielding layer can develop high sliding properties with a small blending amount, so that an amount of lubricant to be blended in the light-shielding layer can be reduced. As a relative effect of reducing the lubricant blending amount in the light-shielding layer, contents of carbon black and fine particles in the light-shielding layer can be increased. Therefore, it is possible to obtain a light-blocking member for optical instruments which keeps physical properties of the light-shielding layer, such as light-shielding properties and delustering properties. As another relative effect of reducing the lubricant blending amount in the light-shielding layer, a content of a binder resin (particularly, a thermosetting resin) in the light-shielding layer can be increased, so that an improvement of adhesiveness of the light-shielding layer to the film substrate can be expected, as well.

According to the invention of the second aspect, by using a specific particulate lubricant, that is, fluorine resin particles as the lubricant to be contained in the light-shielding layer, the light-shielding layer can develop high sliding properties with a small blending amount, so that the lubricant blending amount in the light-shielding layer can be reduced. As a relative effect of reducing the lubricant blending amount in the light-shielding layer to small, a content of a binder resin (particularly, a thermosetting resin) in the light-shielding layer can be increased, so that a light-blocking member for optical instruments, wherein the light-shielding layer has improved heat resistance, can be obtained.

Also, as another relative effect of reducing the lubricant blending amount in the light-shielding layer, contents of carbon black and fine particles in the light-shielding layer can be increased, so that it is possible to obtain a light-blocking member for optical instruments wherein physical properties of the light-shielding layer, such as light-shielding properties and delustering properties, are maintained. Note that as a result that a content of a binder resin in the light-shielding layer can be increased, improvements of adhesiveness of the light-shielding layer to the film substrate and abrasion resistance can be also expected in addition to an improvement of heat resistance.

Since improvements of adhesiveness and abrasion resistance of the light-shielding layer can be expected in the invention of the both aspects, the light-blocking member for optical instruments according to both of the aspects can be preferably used for high-end single-lens reflex cameras, compact cameras, video cameras, cellular phones and projectors, etc. Particularly in recent years, it can be applied to camera-equipped cellular phones, wherein a lens is required to be attached by using reflow soldering.

### BRIEF EXPLANATION OF THE DRAWINGS

FIG. 1 is a sectional view showing a light-blocking member for an optical instrument according to the present embodiment.

Below, a light-blocking member for an optical instrument according to an embodiment of the invention above will be explained.

### <Light-Blocking Member for Optical Instruments>

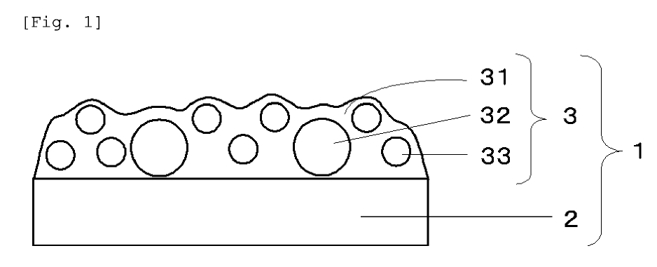

As shown in FIG. 1, a light-blocking member 1 for an optical instrument according to the present embodiment comprises a substrate 2. A light-shielding layer 3 is formed on at least one surface of the substrate 2.

<Substrate>

As a substrate 2 to be used, a polyester film, polyimide film, polystyrene film, polycarbonate film, and other synthetic resin films may be mentioned. Among them, a polyester film is preferably used, and a uniaxial-stretched and, in particular, biaxially-stretched polyester film is particularly preferable in terms of excellent mechanical strength and dimensional stability. Also, a polyimide film is preferably used for heat resistant use. It is as explained above that, in recent years, to mount a lens on a cellular-phone camera, etc., attaching with reflow soldering has gathered attentions when mounting the lens on the substrate.

As the substrate 2, not to mention transparent ones, a foamed polyester film and a synthetic resin film containing carbon black or other black pigment or other pigments may be also used. In this case, suitable one for each use purpose may be selected as the substrate 2. For example, in the case of using as a light-blocking member 1, a light collected by a lens, etc. at a synthetic resin film portion of the section of the member reflects and gives adverse affects, therefore, a synthetic resin film containing black pigment, such as carbon black, may be used when high light-shielding properties are required; and in other cases, transparent or foamed synthetic resin films may be used.

In the present embodiment, since sufficient light-shielding properties as a light-blocking member 1 can be obtained from the light-shielding layer 3 itself, when containing a black pigment in the synthetic resin film, it is good enough to contain to an extent that the synthetic resin film looks visually black, that is, the optical density becomes 3 or so. Accordingly, it is different from the conventional way of containing the black pigment in the synthetic resin film to the limit of undermining the physical properties as the substrate 2, so that the physical properties of the synthetic resin film are not changed and it can be obtained at a low cost.

A thickness of the substrate 2 differs depending on the use purpose, but 25 μm to 250 μm is generally preferable in terms of the strength and rigidity as a light-weight light-blocking member 1.

Also, in terms of improving adhesiveness to the light-shielding layer 3, the substrate 2 may be subjected to an anchor treatment or a corona treatment in accordance with need.

<Light-Shielding Layer>

The light-shielding layer 3 formed on at least one surface of the substrate 2 contains a binder resin, carbon black, a particulate lubricant 32 and a delustering agent 33. Note that, in FIG. 1, the binder resin and carbon black are indicated together by a reference number “31”.

<Binder Resin>

As a binder resin contained in the light-shielding layer 3, a poly(meth)acrylic acid-type resin, polyester resin, polyvinyl acetate resin, polyvinyl chloride, polyvinyl butyral resin, cellulose-type resin, polystyrene/polybutadiene resin, polyurethane resin, alkyd resin, acrylic resin, unsaturated polyester resin, epoxy ester resin, epoxy resin, epoxy acrylate-type resin, urethane acrylate-type resin, polyether acrylate-type resin, polyether acrylate-type resin, phenol-type resin, melamine-type resin, urea-type resin, diallyl phthalate-type resin, polyamide resin, polyimide resin, polyamide-imide resin, polyester polyol resin, acryl polyol resin, epoxy polyol resin and other thermoplastic resins or thermosetting resins may be mentioned; and one or more kinds may be mixed for use. Particularly, when used for heat resistant usage, a thermosetting resin is preferably used.

A content of a binder resin in the light-shielding layer 3 is preferably 50 wt % or higher, more preferably 60 wt % or higher, furthermore preferably 65 wt % or higher and most preferably 70 wt % or higher. When the content of the binder resin is 50 wt % or higher in the light-shielding layer 3, it is possible to prevent a decline of adhesiveness between the substrate 2 and the light-shielding layer 3. On the other hand, the content of the binder resin in the light-shielding layer 3 is preferably 85 wt % or lower, more preferably 80 wt % or lower, and furthermore preferably 75 wt % or lower. When the content of the binder resin in the light-shielding layer 3 is 85 wt % or lower, it is possible to prevent a decline of physical properties of the light-shielding layer, such as light-shielding properties, sliding properties and delustering properties. Particularly, as will be explained later on, by choosing a specific lubricant (explained later on) as the lubricant 32 in a first aspect and by choosing fluorine resin particles as the lubricant 32 in a second aspect, high sliding properties can be secured even when a content of the lubricant 32 is suppressed low in the light-shielding layer 3, and as a relative effect thereof, a content of the binder resin can be increased (for example, 65 wt % or higher) from that in the prior art. As a result, it can contribute to improvements of adhesiveness and abrasion resistance.

<Carbon Black>

Carbon black contained in the light-shielding layer 3 is to provide light-shielding properties by coloring the binder resin black and, at the same time, to prevent electrostatic charge due to static electricity by providing conductivity.

An average particle size of carbon black is preferably 1 μm or smaller and more preferably 0.5 μm or smaller to obtain sufficient light-shielding properties. Note that an average particle size in the present specification indicates a median diameter (D50) measured by a laser diffraction particle analyzer (for example, Shimadzu Corporation: SALD-7000, etc.). It is the same in lubricants and fine particles, etc.

A content of carbon black in the light-shielding layer 3 is preferably 5 to 20 wt %, and more preferably 10 to 20 wt %. When 5 wt % or higher in the light-shielding layer 3, it is possible to prevent a decline of light-shielding properties and conductivity, and when 20 wt % or lower, adhesiveness and scratch resistance (or abrasion resistance) improve, a decline of coating strength can be prevented, and cost rise can be also prevented.

<Fine Particles>

Fine particles 33 contained in the light-shielding layer 3 are to reduce glossiness (specular glossiness) of a surface by forming fine unevenness on the surface to reduce reflection of incident lights and to improve delustering properties when made into a light-blocking member 1.

Fine particles 33 are necessary for providing delustering properties on the surface when made into a light-blocking member 1, however, a ratio of the content in the light-shielding layer 3 is limited as below. First, when increasing a content of the fine particles 33 without changing ratios of a resin and other components, contents of carbon black 31 and lubricant 32, etc. decrease in accordance therewith, it results in a decline of physical properties, such as light-shielding properties and sliding properties, of the light-blocking member 1. While when keeping contents of carbon black and a lubricant in the light-shielding layer to maintain the light-shielding properties and other physical properties, decreasing a content of a binder resin and increasing a content of the fine particles 33, it becomes in short of adhesiveness between the substrate 2 and the light-shielding layer 3, and scratch resistance or abrasion resistance deteriorates. Namely, when the light-shielding layer 3 contains an enough amount of fine particles 33 to give sufficient delustering properties, it results in being unable to maintain physical properties, such as light-shielding properties and sliding properties, or being poor in scratch resistance or abrasion resistance.

In the present embodiment, fine particles having high oil absorption can be used. Specifically, fine particles 33 having oil absorption of preferably 250 (g/100 g) or more, and more preferably 300 (g/100 g) or more can be used. When using fine particles 33 with high oil absorption, delustering properties on the surface can be obtained with a small amount and contents of carbon black 31 and lubricant 32 etc. can be increased in the light-shielding layer 3. As a result, the light-shielding layer 3 is able to develop physical properties, such as light-shielding properties and sliding properties, while keeping delustering properties on the light-shielding layer 3. Note that the oil absorption explained above is based on ISO787/V-1968 and is an oil amount (g) necessary for wet mixing 100 g of fine particles 33 with linseed oil to obtain a hard paste.

As such fine particles 33, any of crosslinked acrylic resin beads (1.19) and other organic type, or silica (1.9), magnesium aluminometasilicate (2.0 to 2.2), titanium oxide, magnesium (1.7) and other inorganic type may be used, but inorganic type is preferable and silica is preferably used among them in terms of dispersibility of the fine particles and the low cost. Also, one or more kinds may be mixed for use from them. Note that the numbers in brackets indicate a density of the substance (the unit is “g/cm³”).

A primary particle size or secondary particle size of the fine particles 33 is preferably 1 to 10 μm, and more preferably 1 to 6 μm. When in the ranges as such, fine unevenness is formed on a surface of the light-blocking member 1 and delustering properties can be obtained.

Note that secondary particles mean particles formed by congregated primary particles. A primary particle size and secondary particle size can be obtained by taking pictures with a transmission-type electron microscope or simply by using a laser scattering type device (for example, a trade name “LA300” made by HORIBA, Ltd.), etc. for measuring a particle size distribution to measure as a median diameter based on the number.

A content of the fine particles 33 in the light-shielding layer 3 is preferably 1 to 10 wt % and more preferably 1 to 5 wt %. When 1 wt % or higher in the light-shielding layer 3, glossiness (specular glossiness) on the surface increases and a decline of delustering properties can be prevented. When 10 wt % or lower, it is possible to prevent dropping of fine particles 33 caused by sliding moves of the light-blocking member 1 and a decline of sliding properties can be prevented.

When particularly high light-shielding properties and sliding properties are required, a content of fine particles 33 is preferably 3 wt % or lower in the light-shielding layer 3. With the fine particles 33 used in the present embodiment, high delustering properties can be obtained even with a small amount as explained above, therefore, sufficient delustering properties can be obtained with 3 wt % or lower. Moreover, contents of carbon black 31 and a lubricant 32 can be increased relatively and physical properties, such as light-shielding properties and sliding properties, can be improved.

<Lubricant>

A particulate lubricant 32 contained in the light-shielding layer 3 is to improve sliding properties on a surface of the light-blocking member 1, to reduce abrasion resistance in operation when processed into a diaphragm member, etc. and to improve scratch resistance or abrasion resistance of the surface.

In the first aspect, those having a higher density (a lubricant having a specific density) than that of fine particles above are used as the particulate lubricant 32. The present inventors found that, by selecting a lubricant having a specific density to use as the particulate lubricant 32 contained in the light-shielding layer 3, an amount of the lubricant 32 on a surface of the light-shielding layer 3 can be reduced, consequently, abrasion resistance of the light-shielding layer 3 improves. Note that when using a lubricant having a specific density, fine particles come to the surface of the coating relatively, therefore, preferable delustering properties can be easily obtained even if a content of the fine particles is small.

Namely, it is considered that a large part of a lubricant 32 having a high density does not reside near the surface of the light-shielding layer 3 and stays inside the coating and, consequently, the sliding properties decline remarkably. However, when experimented, it was discovered that relatively high sliding properties were developed. The reason is not all clear but it is assumed that not all of the blended lubricant in a small amount resides inside and a part thereof stays on the surface of the light-shielding layer 3 without being covered with the fine particles 33.

As a usable lubricant having a specific density in terms of the first aspect, preferably those having a density of 2.0 or higher are used. As such a lubricant, polytetrafluoroethylene (PTFE, 2.2), polytrifluoroethylene (PCTFE, 2.15) and polytetrafluoroethylene-hexafluoro propylene copolymer (FEP, 2.15), etc. may be mentioned. Note that the numbers in brackets indicate, as same as those in the paragraph of fine particles, a density of the substance (the unit is “g/cm³”).

As a second aspect, fluorine resin particles are used as the particulate lubricant 32. Fluorine resin particles include particles containing a fluorine resin. The present inventors found that, by selecting a fluorine resin particles from a number of particulate lubricants to use as the particulate lubricant 32 to be contained in the light-shielding layer 3, high sliding properties can be attained even when a content of the lubricant 32 in the light-shielding layer 3 is reduced (reduced by 40% or so comparing with that in the conventional cases).

As a fluorine resin particles, for example, polytetrafluoroethylene (PTFE), polytrifluoroethylene (PCTFE), polyvinylidene fluoride (PVDF), polyvinyl fluoride (PVF), polytetrafluoroethylene copolymer (ETFE) and polytetrafluoroethylene-hexafluoro propylene copolymer (FEP), etc. may be mentioned.

As polytetrafluoroethylene, for example, commercially available resin wax of Shamrock Technologies (The United States) and Hoechst Japan, Ltd., etc. may be used. Specifically, for example, commercially available SST series of “Shamrock Wax” of Shamrock Technologies and commercially available TF series of “Hostafron” of Hoechst Japan, Ltd. may be mentioned. As the SST series, for example, “SST-1MG” (particle size of about 1 to 2 μm), “SST-2” (particle size of about 12.5 μm), “SST-2P” (particle size of about 12.5 μm), “SST-2D” (particle size of about 9 μm), “SST-3” (particle size of about 5 μm), “SST-3D” (particle size of about 5 μm), “SST-3P” (particle size of about 5 μm), “SST-3H” (particle size of about 5 μm), “SST-4” (particle size of about 4 μm) and “SST-4MG” (particle size of about 2 to 4 μm), etc. may be mentioned. As the TF series, for example, “TF9202” (particle size of about 2.5 μm) and “TF9205” (particle size of about 5 μm), etc. may be mentioned.

As those containing polytetrafluoroethylene, there are, for example, FLUOROSLIP series, etc. of “Shamrock Wax” above. Specifically, “225 (PTFE/PE, particle size of about 12.5 μm)”, “231 (PTFE/PE, particle size of about 6 μm)”, “245 (PTFE/PE, particle size of about 12.5 μm)”, “285 (PTFE/PE, particle size of about 12.5 μm)”, “421T (PTFE/PE, particle size of about 6 μm)”, “425 (PTFE/PE, particle size of about 12.5 μm)”, “511 (PTFE/PE, particle size of about 6 μm)”, “722MG (PTFE/PE, particle size of about 5 μm)” and “731MG (PTFE/PE, particle size of about 3 to 4 μm)”, etc. of the series may be mentioned. The respective particle sizes above indicate average particle diameters.

Note that other than the specific lubricants mentioned above (lubricants having a specific density in the first aspect, and fluorine resin particles in the second aspect. It will be the same below.), organic-type lubricants and inorganic-type lubricants widely known as particulate lubricants may be mixed in an appropriate amount with the specific lubricants mentioned above. In this case, they may be mixed in an amount of about 100 parts or less with respect to 100 parts of the specific lubricant in a weight ratio. When a mixing amount of other lubricant components than the specific lubricant becomes larger, the effects by using the specific lubricant in the present embodiment may be undermined.

An average particle size of the specific lubricant particles is preferably 1 to 20 μm, more preferably 3 to 15 μm, and furthermore preferably 5 to 10 μm. By using a specific lubricant having an average particle size in this range, appropriate unevenness is formed on a surface and sliding properties improve furthermore (for example, a coefficient of dynamic friction becomes furthermore lower).

In the first aspect, it is particularly preferable to use a specific lubricant having a larger average particle size than that of the fine particles 33. When the average particle size of the lubricant is larger than that of the fine particles 33, the lubricant becomes harder to be covered with the fine particles 33 in the light-shielding layer 3. As a result, it becomes easier for the lubricant to reside on the surface of the light-shielding layer 3 and the sliding properties improve, moreover, it contributes to an improvement of delustering properties on the light-shielding layer 3 surface.

A content of the specific lubricant in the light-shielding layer 3 is preferably 5 wt % or higher and more preferably 8 wt % or higher. When 5 wt % or higher in the light-shielding layer 3, appropriate unevenness is formed on the surface and sliding properties can be obtained. In the present embodiment, if a content of the specific lubricant in the light-shielding layer 3 is preferably 15 wt % or lower, more preferably 13 wt % or lower and furthermore preferably 10 wt % or lower, high sliding properties can be obtained. Since the specific lubricant to be used as the lubricant 32 in the present embodiment can provide high sliding properties even with a small amount as explained above, sufficient sliding properties can be obtained with an amount of 15 wt % or lower. Moreover, contents of carbon black, fine particles 33 and a binder resin can be increased relatively, and it can contribute to improvements of abrasion resistance and adhesiveness of the light-shielding layer 3 (first aspect) or to an improvement of heat resistance (second aspect) as well as light-shielding properties and delustering properties, etc.

In the first aspect, a weight ratio of a lubricant 32 and carbon black 31 (lubricant 32/carbon black 31) in the light-shielding layer 3 can be adjusted to preferably 0.90 or lower (0 is omitted), more preferably 0.85 or lower (0 is omitted), furthermore preferably 0.80 or lower (0 is omitted) and most preferably 0.75 or lower (0 is omitted), which are lower than that in the prior art (for example, 1.00 or higher).

When the weight ratio of the lubricant 32 and carbon black 31, lubricant 32/carbon black 31, in the light-shielding layer 3 is adjusted to be in the predetermined range as explained above, abrasion resistance and adhesiveness of the light-shielding layer 3 are expected to be improved while maintaining light-shielding properties, sliding properties and delustering properties at high levels. The reason why the improvements can be expected is because a specific lubricant is selected as the lubricant 32 to be contained in the light-shielding layer 3, a content thereof in the light-shielding layer 3 can be reduced and, as a relative effect thereof, a content of the binder resin in the light-shielding layer 3 can be increased. It is considered that, as a result of increasing the content of a binder resin in the light-shielding layer 3, adhesiveness of the light-shielding layer 3 to the substrate 2 improves and, thereby, abrasion resistance of the light-shielding layer 3 furthermore improves. Particularly, by using a thermosetting resin as the binder resin, abrasion resistance and heat resistance of the light-shielding layer 3 improve.

In the second aspect, a weight ratio of fluorine resin particles and fine particles 33 in the light-shielding layer 3 (fluorine resin particles/fine particles) is preferably 5 or lower (0 is omitted), more preferably 4 or lower (0 is omitted), more preferably 3 or lower (0 is omitted) and is adjusted to be a smaller value (Note that preferably 1 or higher and more preferably 2 or higher.) than that in the prior art (for example, 6 or higher). When the weight ratio of the fluorine resin particles and fine particles 33 in the light-shielding layer 3, fluorine resin particles/fine particles, is in the predetermined range as explained above, heat resistance and abrasion resistance of the light-shielding layer 3 can be improved while maintaining light-shielding properties, sliding properties and delustering properties at high levels. The reason why such effects can be developed is because, as explained above, fluorine resin particles are selected as the lubricant 32 to be contained in the light-shielding layer 3 and a content thereof in the light-shielding layer 3 is reduced and, as a relative effect thereof, a content of a binder resin in the light-shielding layer 3 can be increased. It is considered that, as a result of increasing the content of a binder resin in the light-shielding layer 3, adhesiveness of the light-shielding layer 3 to the substrate 2 furthermore improves and, thereby, abrasion resistance of the light-shielding layer 3 improves. Particularly, by using a thermosetting resin as the binder resin, heat resistance of the light-shielding layer 3 improves.

Note that when setting the weight ratio of fluorine resin particles and fine particles 33 in the light-shielding layer 3 to be 1 or higher, heat resistance, abrasion resistance and adhesiveness of the light-shielding layer 3 can be improved while maintaining light-shielding properties, sliding properties and delustering properties at high levels.

<Other Components>

On the light-shielding layer 3 formed on at least one surface of the substrate 2, a variety of additives can be contained, such as flame retardants, antimicrobial agents, antifungal agents, antioxidants, plasticizers, leveling agents, fluidity control agents, defoaming agents and dispersants, as far as they do not undermine the functions of the present invention.

A thickness of the light-shielding layer 3 is preferably 5 to 30 μm, and more preferably 5 to 20 μm. When it is 5 μm or thicker, it is possible to prevent arising of pin hole, etc. on the light-shielding layer 3 and sufficient light-shielding properties can be obtained. Also, when it is 30 μm or thinner, arising of cracks on the light-shielding layer 3 can be prevented.

The light-blocking member 1 for an optical instrument of the present embodiment can be obtained by applying on one or both surfaces of a substrate 2 a light-shielding layer application liquid including a binder resin, carbon black 31, a particulate lubricant 32 and fine particles 33 as explained above by using a conventionally well-known application method, such as dip coating, roll coating, bar coating, die coating, blade coating and air knife coating, and drying, then, in accordance with need, heating and pressurizing, etc. As a solvent of the application liquid, water, organic solvents and a mixture of water and organic solvent, etc. may be used.

As explained above, since the light-blocking member 1 for an optical instrument of the present embodiment comprises a specific light-shielding layer 3 on at least one surface of the substrate 2, physical properties of a light-shielding layer, such as light-shielding properties and sliding properties, are secured while delustering properties are provided. Therefore, it can be preferably used as members of a shutter and diaphragm of high-end single-lens reflex cameras, compact cameras and video cameras, cellular phones and projectors, etc. Particularly, when the light-shielding layer 3 contains fluorine resin particles as a lubricant 32, which can develop high sliding properties even with a small amount, a content of a binder resin in the light-shielding layer 3 can be increased, consequently, it is possible to obtain a light-shielding layer having excellent abrasion resistance and adhesiveness (first aspect) and a light-shielding layer having excellent heat resistance and abrasion resistance (second aspect). As a result, it is suitable to be used for a shutter and diaphragm, etc. of a camera-equipped cellular phone, wherein reflow soldering is required when attaching a lens in recent years.

### EXAMPLES

Below, the present invention will be explained furthermore with examples. Note that “part” and “%” are based on weight unless otherwise mentioned.

### 1. Producing Light-Blocking Member for Optical Instruments

### Examples 1 to 19

As a substrate, a polyimide film having a thickness of 50 μm (Kapton 200H: DuPont-Toray Co., Ltd.) was used, light-shielding layer application liquids ‘a’ to ‘s’ of the formulas below were respectively applied by using a bar coating method to both surfaces thereof to be a thickness of 10 μm when dried, the results were dried and light-shielding layers ‘A’ to ‘S’ were formed, then, light-blocking members for optical instruments of respective experimental examples were produced. Note that contents (parts) of acrylic polyol, etc. of light-shielding layer application liquids of formulas below are shown in Tables 1 and 2. Also, contents (%) of acrylic polyol, etc. in the formed light-shielding layers are shown in Tables 3 and 4.

### <Formulas of Light-Shielding Layer Application Liquids ‘a’ to ‘s’>

acrylic polyol (solid content 50%) (parts shown in Table 1) (ACRYDIC A804: DIC Corporation)

isocyanate (solid content 75%) (parts shown in Table 1) (BURNOCK DN980: DIC Corporation)

carbon black (parts shown in Table 1) (VULCAN XC-72R: Cabot Corporation)

lubricant shown in Table 1 (parts shown in Table 1)

fine particles shown in Table 1 (parts shown in Table 1)

| | |
|---|---|
| methyl ethyl ketone | 60 parts |
| toluene | 40 parts |

TABLE 1

| | | Materials (parts) | | | | | | | | | | |
|---|---|---|---|---|---|---|---|---|---|---|---|---|
| | | Binder Resin | | | | | | | | | | |
| | Application | Acrylic | | | Carbon | Fine Particles | | | Lubricant | | | |
| Example | Liquid | Polyol | Isocyanate | Total | Black | X | Y | Z | P | Q | R | S |
| 1 | a | 112.1 | 21.9 | — | 13.4 | 4.5 | — | — | 9.5 | — | — | — |
| 2 | b | | | | 13.4 | 4.5 | — | — | — | 9.5 | — | — |
| 3 | c | | | | 13.4 | 4.5 | — | — | — | — | 9.5 | — |
| 4 | d | | | | 13.4 | 4.5 | — | — | — | — | — | 9.5 |
| 5 | e | | | | 13.4 | — | 4.5 | — | 9.5 | — | — | — |
| 6 | f | 109.4 | 21.3 | | 13.1 | 4.4 | — | — | 11.8 | — | — | — |
| 7 | g | 115.6 | 22.5 | | 13.8 | 4.6 | — | — | 6.9 | — | — | — |
| 8 | h | 92.0 | 25.1 | | 16.3 | 4.6 | — | — | — | — | — | 16.3 |
| 9 | i | 92.0 | 25.1 | | 16.3 | 2.6 | — | — | 16.3 | — | — | — |
| 10 | j | 112.1 | 21.9 | | 13.4 | 4.5 | — | — | — | — | — | — |
| 11 | k | 112.1 | 21.9 | | 13.4 | — | — | 4.5 | 9.5 | — | — | — |

TABLE 2

| | | Materials (parts) | | | | | | | | |
|---|---|---|---|---|---|---|---|---|---|---|
| | | Binder Resin | | | | Fine | | | | |
| | Application | Acrylic | | | Carbon | Particles | Lubricant | | | |
| Example | Liquid | Polyol | Isocyanate | Total | Black | X | P | Q | R | S |
| 12 | l | 112.2 | 21.9 | — | 13.45 | 4.50 | 9.50 | — | — | — |
| 13 | m | 112.2 | 21.9 | — | 13.45 | 4.50 | — | 9.50 | — | — |
| 14 | n | 112.2 | 21.9 | — | 13.45 | 4.50 | — | — | 9.50 | — |
| 15 | o | 106.8 | 20.9 | — | 12.80 | 9.10 | 9.07 | — | — | — |
| 16 | p | 109.6 | 21.4 | — | 13.13 | 6.66 | 9.34 | — | — | — |
| 17 | q | 110.7 | 21.7 | — | 13.24 | 5.83 | 9.35 | — | — | — |
| 18 | r | 114.6 | 22.4 | — | 13.75 | 2.40 | 9.75 | — | — | — |
| 19 | s | 92.0 | 25.1 | — | 16.30 | 2.60 | — | — | — | 16.30 |

TABLE 3

| | | Materials (%) | | | | | | | | | | |
|---|---|---|---|---|---|---|---|---|---|---|---|---|
| | Light- | Binder Resin | | | | | | | | | | |
| | Shielding | Acrylic | | | Carbon | Fine Particles | | | Lubricant | | | |
| Example | Layer | Polyol | Isocyanate | Total | Black | X | Y | Z | P | Q | R | S |
| 1 | A | 56.1 | 16.4 | 72.5 | 13.4 | 4.5 | — | — | 9.5 | — | — | — |
| 2 | B | | | | 13.4 | 4.5 | — | — | — | 9.5 | — | — |
| 3 | C | | | | 13.4 | 4.5 | — | — | — | — | 9.5 | — |
| 4 | D | | | | 13.4 | 4.5 | — | — | — | — | — | 9.5 |
| 5 | E | | | | 13.4 | — | 4.5 | — | 9.5 | — | — | — |
| 6 | F | 54.7 | 16.0 | 70.7 | 13.1 | 4.4 | — | — | 11.8 | — | — | — |
| 7 | G | 57.8 | 16.9 | 74.7 | 13.8 | 4.6 | — | — | 6.9 | — | — | — |
| 8 | H | 46.0 | 18.8 | 64.8 | 16.3 | 2.6 | — | — | — | — | — | 16.3 |
| 9 | I | 46.0 | 18.8 | 64.8 | 16.3 | 2.6 | — | — | 16.3 | — | — | — |
| 10 | J | 56.1 | 16.4 | 72.5 | 13.4 | 4.5 | — | — | — | — | — | — |
| 11 | K | 56.1 | 16.4 | 72.5 | 13.4 | — | — | 4.5 | 9.5 | — | — | — |

TABLE 4

| | | Materials (%) | | | | | | | | | |
|---|---|---|---|---|---|---|---|---|---|---|---|
| | Light- | Binder Resin | | | | Fine | | | | | Lubricant/ |
| | Shielding | Acrylic | | | Carbon | Particles | Lubricant | | | | Fine |
| Example | Layer | Polyol | Isocyanate | Total | Black | X | P | Q | R | S | Particles |
| 12 | L | 56.2 | 16.4 | 72.6 | 13.45 | 4.50 | 9.50 | — | — | — | 2.11 |
| 13 | M | 56.2 | 16.4 | 72.6 | 13.45 | 4.50 | — | 9.50 | — | — | 2.11 |
| 14 | N | 56.2 | 16.4 | 72.6 | 13.45 | 4.50 | — | — | 9.50 | — | 2.11 |
| 15 | O | 53.4 | 15.7 | 69.1 | 12.80 | 9.10 | 9.07 | — | — | — | 1.00 |
| 16 | P | 54.8 | 16.1 | 70.9 | 13.13 | 6.66 | 9.34 | — | — | — | 1.40 |
| 17 | Q | 55.3 | 16.2 | 71.5 | 13.24 | 5.83 | 9.35 | — | — | — | 1.60 |
| 18 | R | 57.3 | 16.8 | 74.1 | 13.75 | 2.40 | 9.75 | — | — | — | 4.06 |
| 19 | S | 46.0 | 18.8 | 64.8 | 16.30 | 2.60 | — | — | — | 16.30 | 6.27 |

Note that, in Tables 1 to 4, the lubricant P indicates Shamrock SST-3D (Shamrock Technologies, fluorine resin particles, density 2.2, average particle size 5 μm). The lubricant Q indicates Shamrock SST-2D (Shamrock Technologies, fluorine resin particles, density 2.2, average particle size 9 μm). The lubricant R indicates Shamrock SST-2 (Shamrock Technologies, fluorine resin particles, density 2.2, average particle size 12.5 μm). The lubricant S indicates Ceridust 3620 (Hoechst, polyethylene wax, density 0.96, average particle size 8.5 μm).

Also, the fine particles X indicates TS100 (Evonik Degussa Japan Co., Ltd., silica, density 1.9, average particle size 4 μm, oil absorption 390 (g/100 g)). The fine particles Y indicates Sylysia 470 (Fuji Silysia Chemical Ltd., silica, density 2.15, average particle size 14.1 μm, oil absorption 180 (g/100 g)). The fine particles Z indicates MX-500 (Soken Chemical & Engineering Co., Ltd., crosslinked acrylic resin beads, density 1.19, average particle size 5 μm, oil absorption unknown).

### 2. Evaluation

The light-blocking members for optical instruments obtained in the respective examples as explained above were evaluated on physical properties by methods below. The results are shown in Tables 5 and 6. Note that (1) Evaluation on Light-shielding properties below were evaluated by using samples each obtained by forming light-shielding layer of each formula of the respective examples to be a thickness of 10 μm on one surface of a transparent polyethylene terephthalate film having a thickness of 50 μm (Lumirror T60: Toray Industries Inc.).

(1) Evaluation on Light-Shielding Properties

Optical density of the samples of respective examples was measured based on JIS-K7651:1988 by using an Optical Densitometer (TD-904: GretagMacbeth), and those exceeded 4.0 and in unmeasurable range were evaluated as “∘”, those with 4.0 or lower were evaluated as “x”. Note that a UV filter was used in the measurement.

(2) Evaluation on Sliding Properties

A coefficient of static friction (μs) and a coefficient of dynamic friction (μk) of the light-blocking members for optical instruments obtained in the respective examples were measured based on JIS-K7125:1999 under condition of a load of 200 (g) and a speed of 100 (mm/min). Those with a coefficient of static friction (μs) of smaller than 0.30 were evaluated as “⊚”, those with 0.30 or larger but smaller than 0.35 were “∘”, those with 0.35 or larger were “x”. Also, those exhibited a coefficient of dynamic friction (μk) of smaller than 0.30 were evaluated as “∘” and those with 0.30 or larger were “x”.

(3) Evaluation on Delustering Properties

Glossiness (specular glossiness) (%) of light-shielding layer surfaces of the light-blocking members for optical instruments obtained in the respective examples was measured based on JIS-Z8741:1997. The lower the glossiness is, the more excellent in delustering properties.

(4) Evaluation on Conductivity

Surface resistivity (Ω) of the light-blocking members for optical instruments obtained in the respective examples was measured based on JIS-K6911:1995. Those exhibited a surface resistivity of lower than 1.0×10⁵ were evaluated as “∘”, those with 1.0×10⁵Ω or higher and less than 1.0×10⁸Ω were “Δ”, and those with 1.0×10⁸Ω or higher were “x”.

(5) Evaluation on Adhesiveness

Adhesiveness of the light-blocking members for optical instruments obtained in the respective examples was measured by using a cross-cut tape method conforming to JIS-K5400:1990. Those wherein 10% or larger area of the cross-cut portions was peeled were evaluated as “x”, those with 5% or larger but smaller than 10% were “A”, and those smaller than 5% were “∘”.

Regarding the examples 12 to 19, adhesiveness of the light-blocking members for optical instruments obtained in the respective examples in the case of using a polyester film (Lumirror: Toray Industries Inc.) instead of a polyimide film as the substrate was also evaluated. All of the samples exhibited smaller than 5% of the cross-cut area (the evaluation was “∘”) and the adhesiveness was preferable.

(6) Evaluation on Abrasion Resistance

On the light-shielding layer surface of the light-blocking members for optical instruments obtained by the respective examples, by using an abrasion tester (NUS-ISO-1) and placing sample pieces at a movable portion and fixed portion thereof, an abrasion test was performed under the condition of a load of 500 g and reciprocating for 100 times. Then, glossiness (specular glossiness) of one surface of the samples placed at the fixed portion was measured before and after the abrasion test and the difference was evaluated. The results were evaluated that those exhibited a value of “(glossiness) after the abrasion test−(glossiness) before the abrasion test” being smaller than 1.0 were “∘”, those with 1.0 or larger but smaller than 1.5 were “Δ” and those with 1.5 or larger were “x”.

(7) Evaluation of Heat Resistance

Heat resistance of the light-blocking members for optical instruments obtained by the respective examples was evaluated as below. First, the respective light-blocking members were subjected to a heat treatment at 270° C. for 5 seconds. Then, glossiness on the light-shielding layer surfaces of the respective light-blocking members after the heat treatment was measured based on JIS-Z8741:1997 in the same way as in (3) above. The results were evaluated that those exhibited no change in glossiness before and after the heat treatment or declined glossiness were considered as having heat resistance “∘” and those exhibited increased glossiness after the heat treatment from that before the heat treatment were considered as having no heat resistance “x”.

TABLE 5

| | Light- | Light- | Sliding | | Delustering | | | | |
|---|---|---|---|---|---|---|---|---|---|
| | Shielding | Sheilding | Properties | | Properties | | | Abrasion | Heat |
| Example | Layer | Properties | μs | μk | (%) | Conductivity | Adhesiveness | Resistance | Resistance |
| 1 | A | ◯ | ⊚ | ◯ | 2.5 | ◯ | ◯ | ◯ | ◯ |
| 2 | B | ◯ | ⊚ | ◯ | 2.5 | ◯ | ◯ | ◯ | ◯ |
| 3 | C | ◯ | ⊚ | ◯ | 2.5 | ◯ | ◯ | ◯ | ◯ |
| 4 | D | ◯ | X | ◯ | 1.8 | ◯ | ◯ | X | X |
| 5 | E | ◯ | ⊚ | ◯ | 7.6 | ◯ | ◯ | ◯ | ◯ |
| 6 | F | ◯ | ⊚ | ◯ | 1.8 | ◯ | ◯ | ◯ | ◯ |
| 7 | G | ◯ | ⊚ | ◯ | 2.5 | ◯ | ◯ | ◯ | ◯ |
| 8 | H | ◯ | ◯ | ◯ | 2.5 | ◯ | Δ | X | X |
| 9 | I | ◯ | ⊚ | ◯ | 4.3 | ◯ | Δ | Δ | ◯ |
| 10 | J | ◯ | X | X | 3.4 | ◯ | ◯ | X | ◯ |
| 11 | K | — | — | — | — | — | ◯ | ◯ | ◯ |

TABLE 6

| | Light- | Light- | Sliding | | Delustering | | | | |
|---|---|---|---|---|---|---|---|---|---|
| | Shielding | Shielding | Properties | | Properties | | | Abrasion | Heat |
| Example | Layer | Properties | μs | μk | (%) | Conductivity | Adhesiveness | Resistance | Resistance |
| 12 | L | ◯ | ⊚ | ◯ | 2.2 | ◯ | ◯ | ◯ | ◯ |
| 13 | M | ◯ | ⊚ | ◯ | 2.2 | ◯ | ◯ | ◯ | ◯ |
| 14 | N | ◯ | ⊚ | ◯ | 2.2 | ◯ | ◯ | ◯ | ◯ |
| 15 | O | ◯ | ⊚ | ◯ | 1.1 | ◯ | Δ | Δ | ◯ |
| 16 | P | ◯ | ⊚ | ◯ | 1.1 | ◯ | ◯ | Δ | ◯ |
| 17 | Q | ◯ | ⊚ | ◯ | 1.3 | ◯ | ◯ | ◯ | ◯ |
| 18 | R | ◯ | ⊚ | ◯ | 4.2 | ◯ | ◯ | ◯ | ◯ |
| 19 | S | ◯ | ◯ | ◯ | 2.5 | ◯ | Δ | Δ | X |

### 3. Consideration

From Table 5 and Table 6, the followings can be understood.

(3-1) Light-Shielding Properties, Sliding Properties, Delustering Properties and Conductivity

First, general physical properties (light-shielding properties, sliding properties, delustering properties and conductivity) required for a light-shielding layer of light-blocking members for optical instruments will be reviewed.

As to the examples 1 to 11, satisfactory results were obtained except for a part of the examples (examples 4 and 10). The reason why the example 4 was poor in sliding properties was because a specific lubricant was not used and also the content was too small (9.5 wt %). The reason why the example 10 exhibited poor results was because there was no lubricant mixed therein. Note that a specific lubricant was not used in the example 8 but it is considered that the content was sufficient (16.3 wt %), so that sufficient sliding properties were obtained comparing with those in the example 4.

As to the examples 12 to 19, all examples exhibited satisfactory results.

(3-2) Adhesiveness, Abrasion Resistance and Heat Resistance

Next, adhesiveness, abrasion resistance and heat resistance of the light-shielding layer will be reviewed.

As to the examples 1 to 11, satisfactory results were obtained except for a part of the examples (examples 4, 8, 9 and 10).

As to the adhesiveness, the reason why the example 8 was slightly inferior was considered that because a specific lubricant was not used and also a content of the lubricant could not be suppressed small (16.30 wt %), a content of a binder resin could not be large enough (64.8 wt %). The reason why the example 9 was slightly inferior was considered because even though a specific lubricant was used, a content of the lubricant could not be suppressed small (16.30 wt) and a content of a binder resin could not be large enough (64.8 wt %). The reason why the example 10 exhibited excellent adhesiveness was considered because a content of a binder resin was large enough.

Note that it was confirmed that preferable adhesiveness was obtained when a PET film was used as the substrate in the examples 8 and 9, as well.

Regarding abrasion resistance, the reason why the example 4 was inferior was because a specific lubricant was not used and a lubricant with a smaller density than that of fine particles was used, so that lots of the lubricant resided on the coat surface, consequently, the coat surface became soft and easily damaged. It is the same in the example 8. The reason why the example 9 was slightly inferior was considered because a content of a lubricant was large (16.30 wt %) while a content of a binder resin was small (64.8 wt %).

Note that, being different from the cases of light-shielding properties, sliding properties, delustering properties and conductivity explained above, the reason why the example 8 with larger content of a lubricant than that in the example 4 exhibited poor abrasion resistance as same as the example 4 was because a content of a binder resin could not be large enough (64.8 wt %) as a relative effect of increasing a content of the lubricant (16.30 wt %) in the light-shielding layer. The example 10 was inferior because a lubricant was not mixed therein from the beginning.

Regarding heat resistance, the reason why the example 4 was inferior was because a specific lubricant was not used. It is the same in the example 8.

Note that regarding adhesiveness, abrasion resistance and heat resistance of the light-shielding layer, it was confirmed that if a predetermined relation of density was satisfied with a lubricant, same qualities (adhesiveness, abrasion resistance and heat resistance) can be obtained regardless of a kind of fine particles (inorganic or organic) to be mixed therein (refer to the examples 1, 5 and 11).

The examples 12 to 19 were reviewed as below.

In the example 19, the specific particulate lubricant used in the examples 12 to 18 was not used, a content of the lubricant in the light-shielding layer was high (16.30 wt %) and, as a relative effect thereof, a content of a binder resin could not be high enough (64.8 wt %). As a result, adhesiveness and heat resistance of the light-shielding layer were poor. Also, there were some tendencies observed that a weight ratio of the lubricant and fine particles (lubricant/fine particles) became large (6.27) in the light-shielding layer and adhesiveness and abrasion resistance of the light-shielding layer declined.

On the other hand, in the examples 12 to 18, since a specific particulate lubricant was used, even if a content of the lubricant in the light-shielding layer was reduced (16.30 wt % in the example 19 and 9.07 to 9.75 wt % in the examples 12 to 18) comparing with that in the example 19, high sliding properties were obtained, and heat resistance and abrasion resistance were excellent. Also, as a relative effect of lowering a content of a lubricant in the light-shielding layer, a content of a binder resin can be higher (69.1 wt % or higher), as a result, adhesiveness of the light-shielding layer was excellent.

As is understood from the results of the example 15, when a content of a lubricant is lower (9.07 wt %) than that in the examples 12 to 14, a content of fine particles (delustering agent) has to be higher (9.10 wt % in the example 15 and 4.50 wt % in the examples 12 to 14). Consequently, weight ratio of the lubricant and fine particles in the light-shielding layer (lubricant/fine particles) becomes small (1.00). Therefore, when comparing with the examples 12 to 14, abrasion resistance of the light-shielding layer is liable to be lower, however, the abrasion resistance is considered excellent enough even when declined as such.

In the examples 16 and 17, contents of the lubricant were lower (9.34 wt % and 9.35 wt %) than those in the examples 12 and 14 but higher than that of the example 15, therefore, an increase of fine particles (delustering agent) is suppressed (6.66 wt % and 5.83 wt %). As a result, lowering of a weight ratio of a lubricant and fine particles in the light-shielding layer (lubricant/fine particles) was suppressed (1.40 and 1.60) comparing with that in the example 15. Consequently, a declining tendency of abrasion resistance of the light-shielding layer was prevented comparing with the case of the example 15. As a relative effect of suppressing an increase of contents of fine particles (delustering agent) in the light-shielding layer, contents of a binder resin can be higher (70.9 wt % and 71.5 wt %) than that in the example 15, therefore, adhesiveness of the light-shielding layer was improved.

In the example 18, a content of a lubricant was higher (9.75 wt %) comparing with those in the examples 12 to 14, and a content of a binder resin could be high (74.1 wt %). As a result, a content of fine particles in the light-shielding layer had to be lowered (2.40 wt %), but even so, sufficient delustering properties (4.2%) were obtained, and adhesiveness, abrasion resistance and heat resistance were all excellent.

### DESCRIPTION OF NUMERICAL NOTATIONS

1 . . . light-blocking member for optical instrument, 2 . . . substrate, 3 . . . light-shielding layer, 31 . . . binder resin and carbon black, 32 . . . lubricant, 33 . . . fine particles

1. A light-blocking member for optical instruments, comprising a film substrate and a light-shielding layer formed on at least one surface of the substrate, wherein:
the light-shielding layer comprises a binder resin, carbon black, a particulate lubricant and fine particles;
contents of the binder resin and the lubricant are 65 wt % or higher and 5 to 15 wt %, respectively; and
the lubricant has a higher density than a density of the fine particles.

2. The light-blocking member for optical instruments according to claim 1, wherein a content of the lubricant is 10 wt % or lower.

3. The light-blocking member for optical instruments according to claim 1, wherein a density of the lubricant is 2.0 (g/cm³) or higher.

4. The light-blocking member for optical instruments according to claim 1, wherein the lubricant has an average particle size of 5 to 10 μm.

5. The light-blocking member for optical instruments according to claim 1, wherein the lubricant is fluorine resin particles.

6. The light-blocking member for optical instruments according to claim 5, wherein a weight ratio of the fluorine resin particles and the fine particles is 5 or lower in fluorine resin particles/fine particles.

7. The light-blocking member for optical instruments according to claim 5, wherein a weight ratio of the fluorine resin particles and the fine particles is 3 or lower in fluorine resin particles/fine particles.

8. The light-blocking member for optical instruments according to claim 1, wherein contents of the carbon black and fine particles are 5 to 20 wt % and 1 to 10 wt %, respectively.

9. The light-blocking member for optical instruments according to claim 1, wherein the binder resin is a thermosetting resin.

10. The light-blocking member for optical instruments according to claim 1, wherein the film substrate is a polyimide film.

11. The light-blocking member for optical instruments according to claim 1, wherein the fine particles has oil absorption of 250 (g/100 g) or more.

12. The light-blocking member for optical instruments according to claim 2, wherein a density of the lubricant is 2.0 (g/cm³) or higher.

13. The light-blocking member for optical instruments according to claim 2, wherein the lubricant has an average particle size of 5 to 10 μm.

14. The light-blocking member for optical instruments according to claim 3, wherein the lubricant has an average particle size of 5 to 10 μm.

15. The light-blocking member for optical instruments according to claim 2, wherein the lubricant is fluorine resin particles.

16. The light-blocking member for optical instruments according to claim 3, wherein the lubricant is fluorine resin particles.

17. The light-blocking member for optical instruments according to claim 4, wherein the lubricant is fluorine resin particles.

18. The light-blocking member for optical instruments according to claim 15, wherein a weight ratio of the fluorine resin particles and the fine particles is 5 or lower in fluorine resin particles/fine particles.

19. The light-blocking member for optical instruments according to claim 16, wherein a weight ratio of the fluorine resin particles and the fine particles is 5 or lower in fluorine resin particles/fine particles.

20. The light-blocking member for optical instruments according to claim 17, wherein a weight ratio of the fluorine resin particles and the fine particles is 5 or lower in fluorine resin particles/fine particles.
